(19) United States
(12) Patent Application Publication
(10) Pub. No.: US 2013/0009778 A1
(43) Pub. Date: Jan. 10, 2013

(54) PATIENT MONITORING DEVICE AND METHOD

(75) Inventor: Basil C. Bautovich, Australian Capital Territory (AU)

(73) Assignee: CONSENG PTY LTD, Cook (AU)

(21) Appl. No.: 13/638,397

(22) PCT Filed: Mar. 30, 2011
(86) PCT No.: PCT/AU2011/000363

§ 371 Date: Sep. 28, 2012

(30) Foreign Application Priority Data
Mar. 30, 2010 (AU) 2010901391

(51) Int. Cl. G08B 21/22

(52) U.S. Cl. 340/573.4

(57) ABSTRACT

One embodiment provides a patient monitoring device (100). Device (100) includes a monitoring module (101), which in turn includes a field generator component. In this embodiment, the field generator component includes a pair of infrared beam sensors (102), each for generating a respective patient monitoring field (103). The monitoring module (101) is configured to generate a signal in response to a breach of that field (103). The device (100) also includes a proximity based token reader in the form of a transceiver (105) configured for remotely reading an identifier carried by a token in the form of a key card 106 when that token is located within a recognition zone (107) defined relative to the proximity based token reader (105).

### FIELD OF THE INVENTION

The present invention relates generally to patient monitoring, and more specifically to a patient monitoring devices and methods.

Embodiments of the invention have been particularly developed for use within healthcare facilities such as hospitals and nursing homes, for example as bed monitors intended to reduce the risk of patient falls and/or offer patient security against unauthorized entry to the bed. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In many cases, individuals such as patients in a hospital or a nursing home require constant physical care and attention from caregivers. Due to costs and resource limitations there are typically many more patients requiring care than there are caregivers—such as nurses or other health service professionals—in any given organisation. Therefore, it is not always possible to administer personal physical care and support to each and every patient that may warrant such attention.

Known methodologies that attempt to ameliorate this problem include the use of personal monitoring systems (such as infrared systems), video surveillance systems, pressure sensitive mats on a bed surface, physical barriers to patient movement, or the like. These types of approaches have a number of disadvantages. For example, it is necessary for physical barriers to be fixed in place, involving cost both at the stage of provisioning and, if the barrier is no longer required or needs to be moved, at the stage of removal or relocation. There is also the additional risk of the patient becoming entrapped or imprisoned by the barrier, or injured when attempting to defeat the barrier. Video surveillance systems, on the other hand, are usually expensive and still require the caregiver to constantly monitor the patient, albeit remotely. If the caregiver is distracted—be that legitimately or otherwise—the surveillance will be compromised. This then increases the risk of a patient being left wholly without care, or increases the time for care to be provided. In some instances this can result in the patient being injured, or further injured, before a caregiver has the opportunity to take any action.

There is a need in the art for improved patient monitoring devices and methods.

### SUMMARY OF THE INVENTION

It is an object of the present invention to overcome or ameliorate at least one of the disadvantages of the prior art, or to provide a useful alternative.

One embodiment provides a patient monitoring device including:
a monitoring module including a field generator component for generating a patient monitoring field, the monitoring module being configured to generate a signal in response to a breach of that field; and
a proximity based token reader configured for remotely reading an identifier carried by a token when that token is located within a recognition zone defined relative to the proximity based token reader.

In embodiments, the proximity based token reader is configured to assess the remotely read identifier to determined whether a shutoff condition is met, and in the case that the shutoff condition is met, transmit a shutoff signal to the monitoring module; and the monitoring module is responsive to the shutoff signal for adopting a shutoff state. In some embodiments, in the case that the shutoff condition is met, the monitoring module either disables the field generator, or disables generation of the signal in response to a breach of the field.

In other embodiments, determining whether a shutoff condition is met includes comparing the read token with a set of token assessment criteria.

In embodiments, the set of token assessment criteria includes one or more of:
a fully authorised read token criteria;
a partially authorised read token criteria; and
a temporary authorised read token criteria.

In further embodiments, the module includes one or more beam sensors that project the patient monitoring field.

In yet further embodiments, the device includes one or more outputs for providing an output signal externally of the device in response to a breach of the field. In one embodiment, the monitoring module includes a communications component for providing the output signal to any one or more of:
a nurse call system;
an alarm unit; and
a communications network.

In an alternate embodiment, the device includes a communications component for providing, externally of the device, data indicative of the operation of the device. In one embodiment, the data indicative of operation of the device includes one or more of:
an event; and
an event time.

In an embodiment, the data includes data indicative of operation of the monitoring module. In another embodiment, the data includes data indicative proximity based token reader.

In further embodiments, data includes data indicative of the monitoring module and proximity based token reader whereby the data is correlated according to one or more common parameters. In one embodiment, one or more common parameters includes a time of an event.

Another embodiment provides a monitoring system for storing event data including:
a patient monitoring device according to any one of the preceding claims; and
central database for receiving and storing, from the device, event data indicative of the operation of the device.

A further embodiment provides a monitoring system for storing event data including:
a patient monitoring device according to any one of the preceding claims; and
one or more computers having a database for receiving and storing, from the device, event data indicative of the operation of the device.

In embodiments, the device is mounted to a bed. In other embodiments, the device is mounted to a wall. In yet other embodiments, the device is mounted to a stand that can be set at a predetermined height above the floor. In yet further embodiments, the device is integrally formed into a wall panel.

Another embodiment provides a recognition token for use with the patient monitoring device of any of the preceding claims wherein the card includes a unique identifier.

An further embodiment provides a method for operating a patient monitoring device including:
using a monitoring module including a field generator component to generate a patient monitoring field, the monitoring module being configured to generate a signal in response to a breach of that field; and
providing a proximity based token reader configured for remotely reading an identifier carried by a token when that token is located within a recognition zone defined relative to the proximity based token reader.

In an embodiment, the method of the above embodiment also includes:
remotely reading an identifier carried by a token when that token is located within the recognition zone defined relative to the proximity based token reader; and
selectively providing a signal in response to reading the token.

In further embodiment, the signal includes a signal for either disabling the field generator, or disabling generation of the signal in response to a breach of the field.

Another embodiment provides a computer readable medium carrying a set of instructions that when executed by one or more processors cause the one or more processors to perform a method according to any one of the above embodiments.

Other embodiments provide method for operating patient monitoring devices as described herein, computer systems configured to administer a collection of patient monitoring devices as described herein, as well as software (for example embodied on computer readable media) for such devices and systems.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a schematic representation of a patient monitoring arrangement according to one embodiment.

FIG. 2A is a schematic representation of a patient monitoring device according to one embodiment.

FIG. 2B is a schematic representation of a patient monitoring device according to another embodiment.

FIG. 3 a schematic representation of a number of patient monitoring devices in communication with a central computer system according to one embodiment.

FIG. 4 is a schematic representation of two patient monitoring devices monitoring adjacent beds according to one embodiment.

FIG. 5 is a schematic representation of two patient monitoring devices monitoring adjacent beds, according to another embodiment.

FIG. 6 is a schematic representation of a patient monitoring device according to one embodiment, in communication with a central computer system.

FIG. 7A is a schematic front view representation of a patient monitoring device according to one embodiment.

FIG. 7B is a schematic top view representation of the patient monitoring device of FIG. 7A.

FIG. 8A is a schematic enlarged front representation of one sensor carriage of the device of FIGS. 7A and 7B.

FIG. 8B is a schematic enlarged plan representation of the sensor carriage of FIG. 8A.

FIG. 9 is a schematic enlarged representation of the main body of the device of FIGS. 7A and 7B.

### DETAILED DESCRIPTION

One embodiment provides a patient monitoring device 100. Device 100 includes a monitoring module 101, which in turn includes a field generator component. In this embodiment, the field generator component includes a pair of infrared beam sensors 102, each for generating a respective patient monitoring field 103. The monitoring module 101 is configured to generate a signal in response to a breach of that field 103. The device 100 also includes a proximity based token reader in the form of a transceiver 105 configured for remotely reading an identifier carried by a token in the form of a key card 106 when that token is located within a recognition zone 107 defined relative to the proximity based token reader 105.

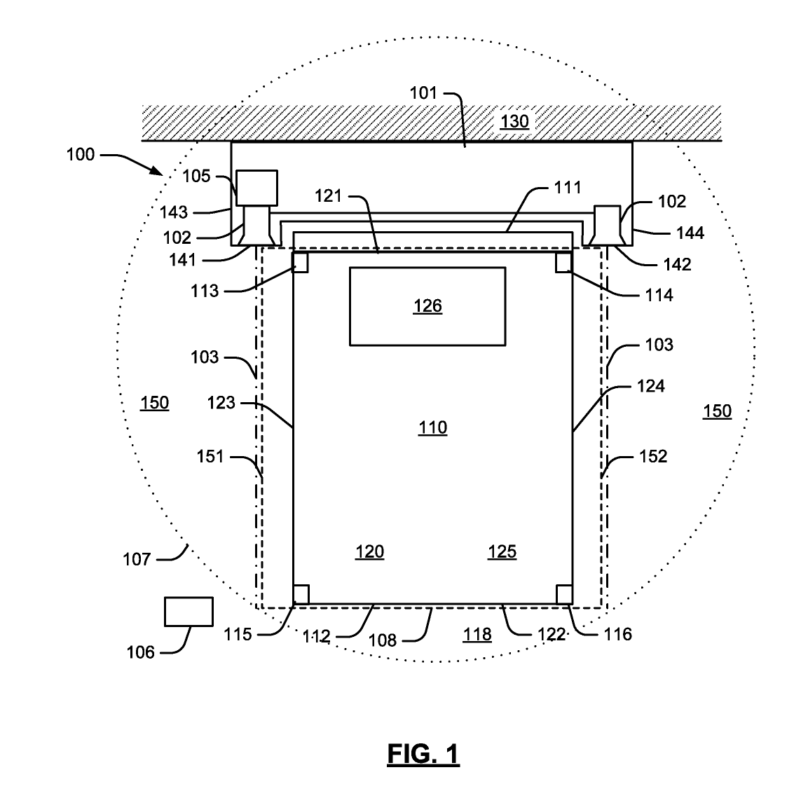

As illustrated in FIG. 1, the patient monitoring fields 103 are positioned either side of a monitoring zone 108 that includes a bed 110. Bed 110 extends longitudinally between a tubular metal bed head 111 and a spaced apart tubular metal bed foot 112. Bed head 111 includes a pair of transversely spaced apart generally parallel and vertical tubular bedposts 113 and 114, while foot 112 includes a further pair of correspondingly transversely spaced apart bedposts 115 and 116. Bed 110 also includes a generally rectangular metal tube bed frame 117 that is suspended horizontally between the bedposts and maintained a fixed distance above the underlying surface. In this embodiment the underlying surface is a substantially planar floor 118. In other embodiments the bed head, bed foot and frame are made from other materials or combinations of materials such as metal, wood, composites, laminates, or meshes.

In other embodiments, the monitoring zone 108 includes one or more objects, other than a bed, from which a patient can be monitored. For example, in other alternate embodiments, the monitoring zone includes a cot, a cot-bed or a chair.

Frame 117 supports a generally rectangular single bed mattress 120 which extends substantially horizontally and longitudinally between a first end 121 that is adjacent to bed head 111 and a second end 122 that is adjacent to foot 112 and generally parallel with end 121. The mattress also extends transversely between two opposite and generally parallel sides 123 and 124. Ends 121 and 122 and sides 123 and 124 collectively define a substantially rectangular horizontal support surface 125 for the individual. As illustrated in FIG. 1, bed 110 also includes a pillow 126 that, in normal use, is disposed adjacent to bed head 111 and upon which the patient rests their head. It will be appreciated that additional or other pillows or other support aids are also available for use with bed 110. Moreover, as would be appreciated by those skilled in the art, bed 110, and mattress 120 in particular, is typically covered by one or more removable sheets, blankets, waterproof liners or other sheet materials.

Device 100 is secured to a wall 130 vertically above the plane of surface 125. In this embodiment, the placement is such that each beam sensor 102 generates their respective field 103 at:
About 150 mm above surface 125 and about 150 mm transversely offset from and generally parallel with side 123; and
About 150 mm above surface 125 and about 150 mm transversely offset from and generally parallel with side 124.

In other embodiments alternative placements of device 100 are used to provide different positioning of fields 103. It will be appreciated by those skilled in the art that the placement of device 100 will also be determined by the nature and type of radiation used to establish fields 103. In some embodiments, the positioning of the beam sensors 102 is individually adjustable to accommodate different setups and sizes of the monitoring zone 108.

The pair of beam sensors 102 is differentiated as a master monitor sensor 141 and a slave monitor sensor 142 which are positioned at opposite ends 143 and 144 of module 101, respectively. It is shown in FIG. 1 that end 143 is substantially adjacent post 113 and end 144 is substantially adjacent post 114. The sensors 141 and 142 are spaced apart approximately 1350 mm to accommodate the width of a standard bed. In other embodiments, sensors 141 and 142 are other than 1350 mm depending on the width required for the monitoring zone. For example, in one embodiment, the sensors are approximately 1000 mm apart to give protections over bed rails when they are raised in a hospital bed.

In other embodiments, the master sensor unit 141 and slave sensor unit 142 are positioned at respective opposite ends 144 and 143 of module 101. In other embodiments, the slave sensor unit 142 is not included and bed 110 has a bedrail or other physical barrier that extends along side 123. In further embodiments, the like unit 9 is not required as either side 123 or side 124 is adjacent to a wall or other barrier. In still further embodiments an alternative form of module 101 is used to provide the required pairs of fields 103 adjacent to sides 123 and 124.

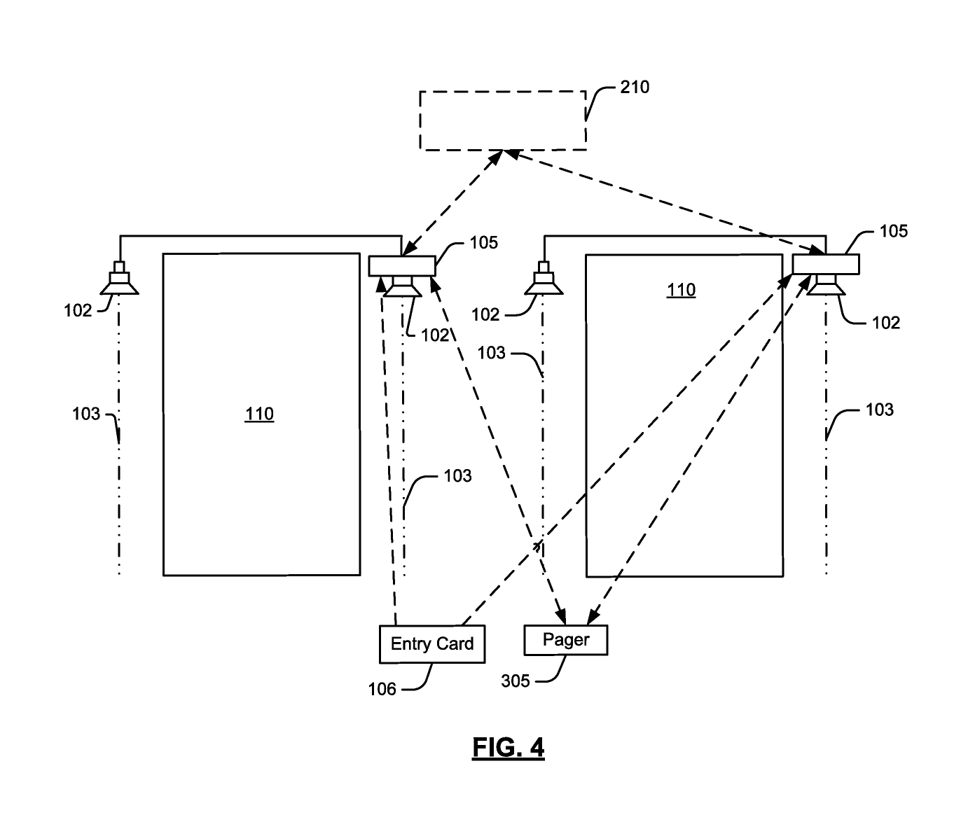

In a particularly preferred embodiment shown in FIG. 5, the proximity based token reader 105 is spaced apart from a pair of monitoring modules 101 either side of bed 110. The modules 101 are hard wired to the token reader 105. This is advantageous as, if either module fails; the other module will continue to monitor the bed on one side, rather than a master sensor unit and a slave sensor unit where the slave sensor unit is dependent on the master sensor unit.

In another embodiment, the slave sensor unit 142 is physically and functionally the same as master sensor unit 141. In essence, the two master sensor units used, function independently with respect to each other, rather than a master sensor unit and a slave sensor unit where the slave sensor unit is dependent on the master sensor unit.

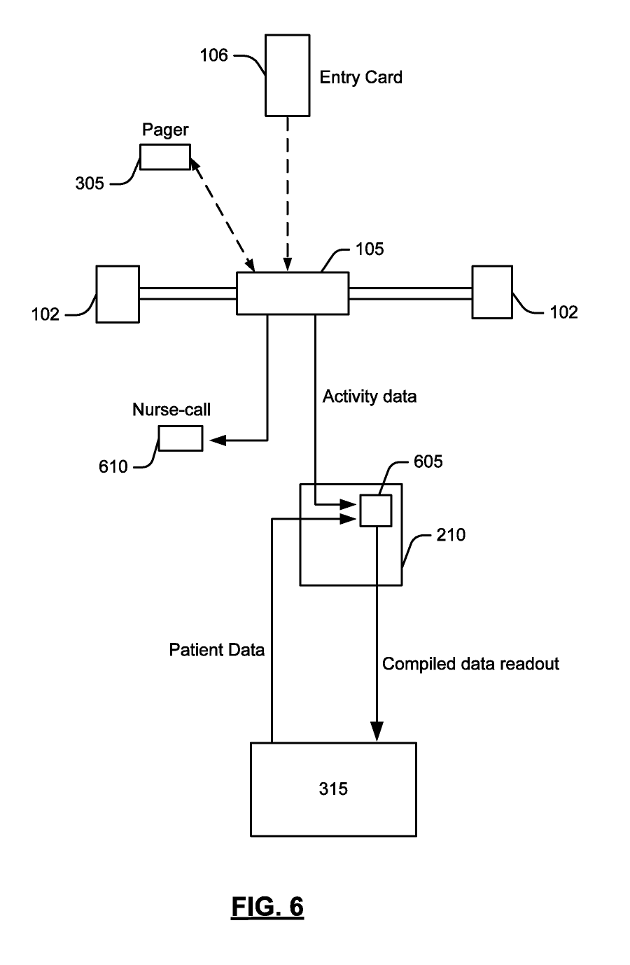

Referring to FIGS. 7A and 7B, there is shown a preferred embodiment of device 101 including a main housing 701 and a pair of slideably adjustable sensor carriages 702. As mentioned above, the maximum width of the opposing carriages 702 is 1350 mm in an open position. In the complete retracted position (not shown) the carriages 702 retreat into body 701 and extend to a minimum width of 1000 mm. In other embodiments, the carriages extend beyond 1350 mm and retract to a lesser width than 1000 mm.

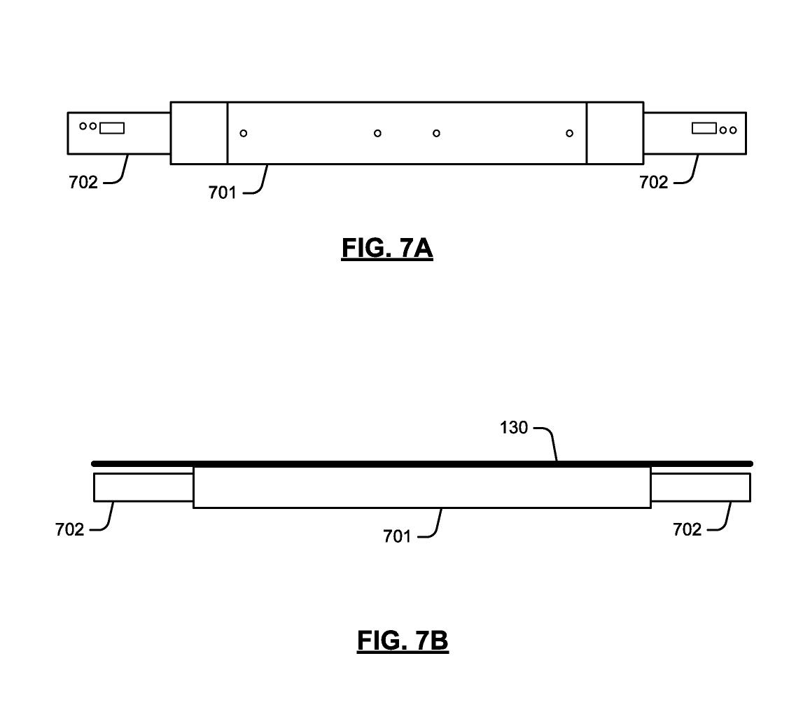

Referring now to FIGS. 8A and 8B, each carriage 702 houses one monitoring module 101. Each carriage 702 includes an LED display unit 801 this is part of a module 101. Display unit 801 powers and controls a power indicator LED 802 and an operation indicator LED 803. LED 802 indicates that the monitoring module 101 is turned on by illuminating green. If the monitoring module 101 is turned off, LED 802 will illuminate red. In other embodiments, different LED indicators are used to show that the module 101 is turned on or off. LED 803 indicates whether or not the patient monitoring field 103 is being presently generated. If the field 103 is being generated, the LED 803 will illuminate orange. If the field 103 is not being generated, the LED 803 will not illuminate. In other embodiments, if the field 103 is being generated, the LED 803 will flash orange illumination. In other embodiments, different LED indicators are used to show that the field 103 is being generated or not.

Each LED 802 and 803 are externally visible through a pair of holes 806 and 807, respectively, in carriage 702. The holes are about 3 mm in diameter. However, in other embodiments, holes 806 and 807 are other than 3 mm in diameter.

Carriage 702 also includes a red acrylic window 804 for allowing module 101, which is housed within carriage 702, to externally generate field 103. Window 804 is about 60 mm width by 18 mm height. In other embodiments, window 804 is other than 60 mm width by 18 mm height. Carriage 702 is slideable along an axis 805.

In the embodiment of FIGS. 8A and 8B, module 101 is about 44 mm wide by 77 mm long by 19 mm deep. However, in other embodiments, module 101 is other than about 44 mm wide by 77 mm long by 19 mm deep. The internal cross-section of carriage 702 is about 78 mm by 50 mm. In other embodiments, the internal cross-section will vary as required to house module 101.

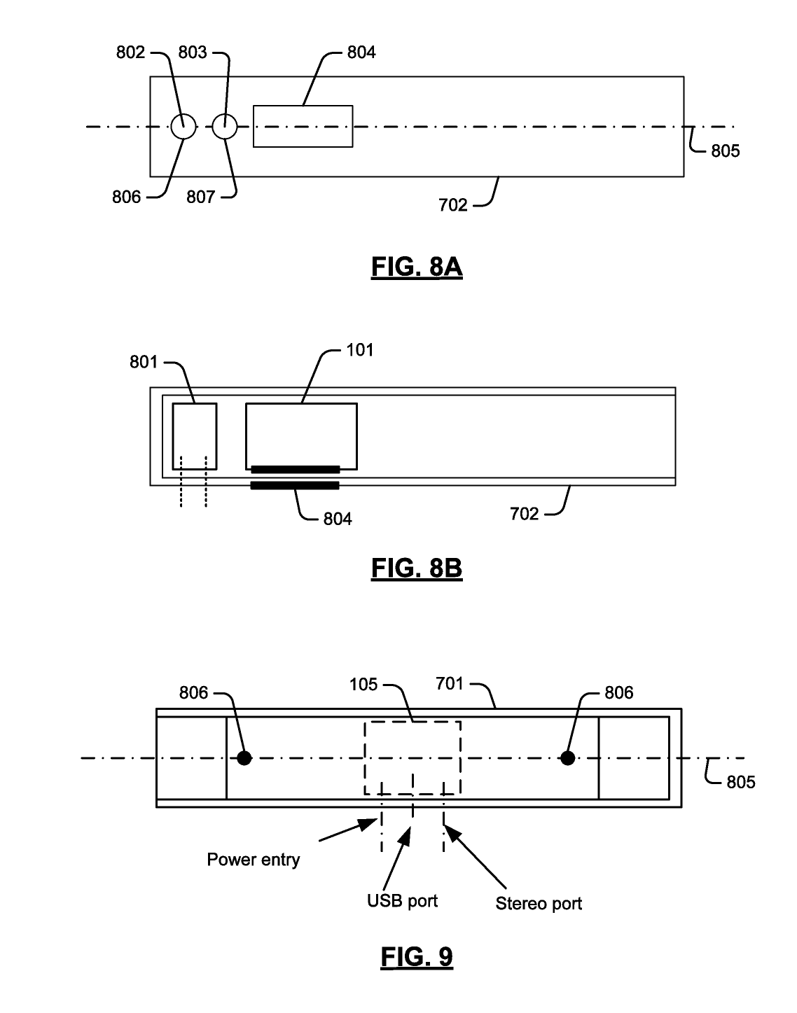

Referring to FIG. 9, the token reader 105 is housed within body 701. In this embodiment, the internal cross-section of body 701 is about 90 mm by 52 mm. In other embodiments, the internal cross-section will vary as required to house token reader 105. Body 701 includes a pair of carriage stops 806 for abuttingly engaging a respective one of the carriages 702 to limit the sliding movement of each carriage 702, for defining the complete retracted position. As indicated, body 703 allows for the access of a power entry, USB connection and stereo connection to the token reader 105.

Referring back to FIG. 1, zone 108 extends upwardly from surface 125 and defines a volume in which the individual would typically occupy when making use of bed 110. Zone 108 includes a boundary that is generally rectangular when viewed from above, which is represented by the broken line indicated by reference numeral 108.

In the event the individual progresses from surface 125 of bed 110, there is a need to move from zone 108—that is, to cross the boundary of zone 108—and into the surrounding room 150. Bed head 111 and foot 112 provide a barrier to the progress of the individual from bed 110 into room 150, which makes movement in a direction perpendicular to either side 123 or 124 the path of least resistance for movement between zone 108 and room 150. Accordingly, normal movement of the individual between zone 108 and room 150 will result in movement across either of the two portions 151 or 152 of the boundary of zone 108. As illustrated in FIG. 1, portion 151 extends longitudinally between bedposts 113 and 115 and portion 152 extends longitudinally between bedposts 114 and 116.

It will be appreciated by those skilled in the art that the FIG. 1 embodiment is primarily for use with individuals such as hospital patients and the elderly, who in normal circumstances are unlikely to attempt to progress from zone 108 to room 150 other than via either of the two portions 151 or 152. For those more active individuals, use is also made of one or more additional like sensors 102 that provide fields which extend along the boundary of zone 108 adjacent to bed head 111 and foot 112.

Field 103 can be breached from either the patient moving from within zone 108 into the room 150, or from an outsider moving from outside the zone 108 to within it.

For more elderly individuals the usual technique for moving from bed 110 to room 150 is to first lie on their side then move one or both or their lower limbs over one of edges 123 or 124, which typically results in the feet or lower legs entering into and breaching field 103. Consequently, the signal 104 is generated in response to the breach of that field 103.

In other embodiments, the device is releasably secured to wall 130 such that it can be released and placed in other locations. In other embodiments, device 100 is integrally formed with a prefabricated wall panel. In other embodiments, device 100 mounted on a stand or free-standing support structure.

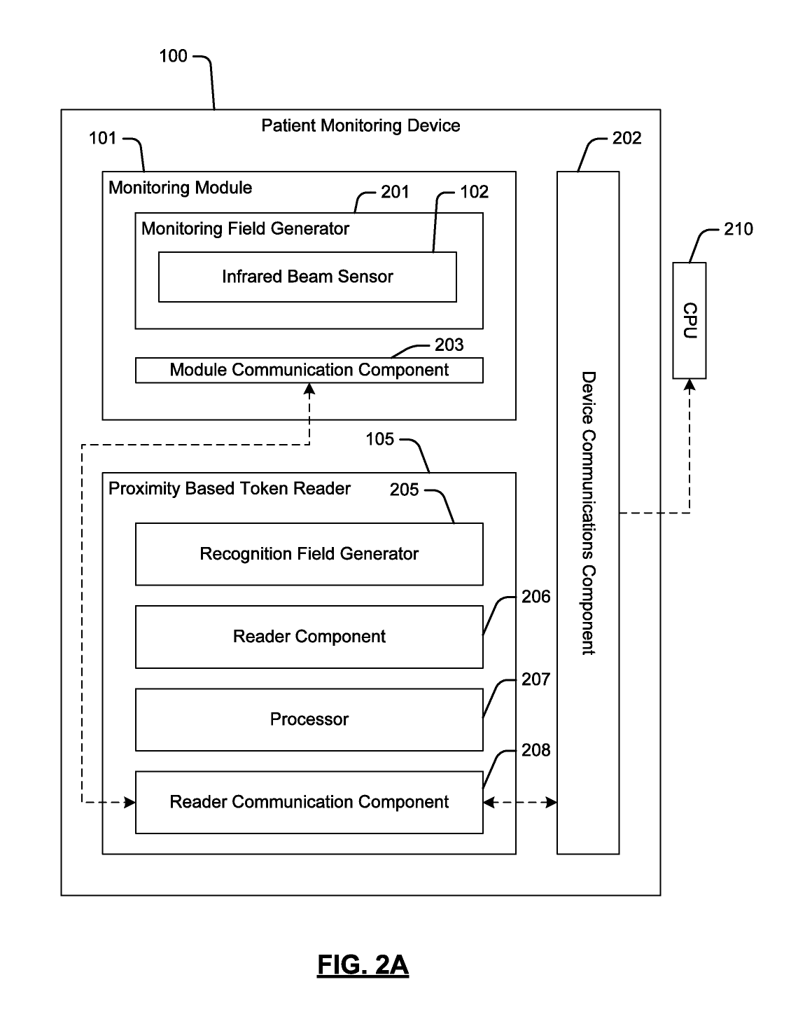

FIG. 2A illustrates a monitoring device 100 according to one embodiment. Device houses the monitoring module 101 and the proximity based token reader 105. The monitoring module includes a field generator 201 in the form of infrared beam sensor 102 for projecting a field in the form of an infrared beam.

In this embodiment, the infrared beam sensor in FIG. 2A represents the master monitor sensor 141 and the slave monitor sensor 142 (from FIG. 1). It is noted that the master sensor 141 is linked to a communications component 202 via token reader 105 and the slave sensor 142 is linked to the master sensor 141. Therefore, if the field of the slave sensor 142 is breached, this will be communicated to the master sensor 141 and subsequently communication to the communications component 202.

Referring to FIG. 2B (which relates to the embodiment shown in FIG. 5), where the proximity based token reader 105 is spaced apart from a pair of monitoring modules 101, the monitoring module 101 includes a monitor communication module that communicates with the token reader 105 via reader communication component 208. Component 208 in turn communicates with the communications component 202 (shown in FIGS. 2A and 2B). In the embodiment shown in FIG. 2B, the same component is used for the communications component 202 and component 208 and this combined component (denoted by 202/208) is housed in the token reader 105.

Referring now to both FIGS. 2A and 2B, the proximity based token reader 105 includes a recognition field generator 205 that generates a field defining the recognition zone for identifying the identifier in the form of a radio-frequency identification tag carried by card 106. A field (denoted by 103 in FIG. 1) that generates the recognition zone 107 is generally an outwardly generated field having a radius of about 3 meters. In other embodiments, the field is more or less than about 3 meters. In other embodiments, the field has a radius between 1 and 4 meters.

The proximity based token reader 105 also includes a reader component 206 that is configured to assess a radio-frequency identification tag within in the recognition zone. The proximity based token reader 105 also has a processor 207 having a transceiver (for example an 802.11 type transceiver, not shown) that receives the information read from a radio-frequency identification tag. This information includes, amongst others, an identification number corresponding to the token. The processor 207 then determines whether a shutoff condition is met. This shutoff condition may occur when the serial number of the radio-frequency identification tag meets predetermined criteria (for example these criteria are defined to establish whether a caregiver is present, by association of certain tokens with caregivers). The criteria includes, amongst others, the following:
A fully authorised read token criteria that would, for example, correspond to the authorisation allocated to a doctor and/or a nurse in a hospital.
A partially authorised read token criteria that would, for example, correspond to the authorisation allocated to a cleaner in a hospital.
A temporary authorised read token criteria that would, for example, correspond to the authorisation allocated to a visitor of a patient in a hospital.

In an embodiment, a fully authorised read token would, always meets a shutoff condition; a partially authorised read token would meet a shutoff condition during predetermined cleaning hours; and a temporary authorised read token would meet a shutoff condition during the predetermined hospital visiting hours.

In the case that a shutoff condition is met a shutoff signal is transmitted to the monitoring module 101. When the monitoring module 101 receives the shutoff signal, the monitoring module 101 is responsive to the shutoff signal and adopts a shutoff (inactive) state. The shutoff state includes the monitoring field generator 201 disarming whereby the beam sensors 102 are turned off. In another embodiment, the shutoff state allows breaches to be recorded, but disables the sounding of an alarm.

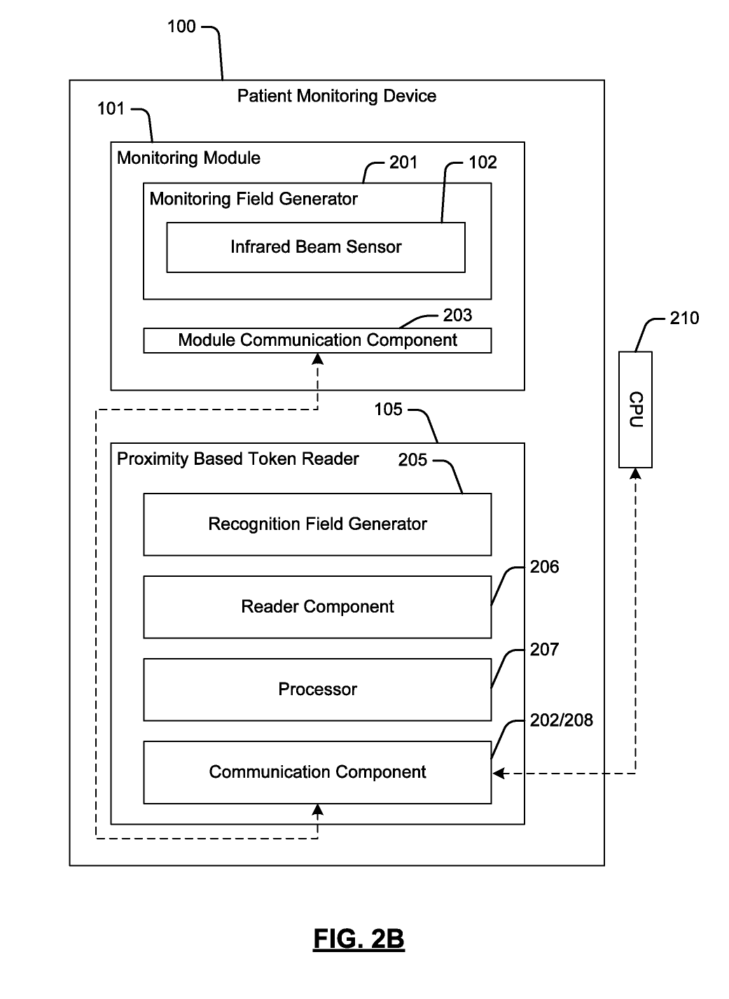

The card 106, which carries the radio-frequency identification tag, is a card carried by a nurse or caregiver. In other embodiments the token is a component of a pager carried by a nurse or caregiver (shown in FIG. 3 denoted by numeral 305). The radio-frequency identification tag takes the form of a transponder that continuously pulses a signal containing the unique serial number of the radio-frequency identification tag. The pulsed signal has range of 1 to 1.5 meters. However, in other embodiments, the range will be less than 1 or more than 1.5 meters. In the present embodiments, use is made of active RFID, whereby the tokens include powered transponders, however other embodiments re implemented with passive RFID, or wireless read technologies other than RFID.

In some embodiments, token reader 105 includes a transponder reception component as an alternative to the recognition field generator 205. Since there is no recognition filed present, this embodiment relies on the continuously pulsed signal of card 106 provide indication of the presence of a caregiver.

In embodiments, reader component 206 assesses the strength of a radio-frequency identification tag within in the recognition zone to produce signal strength information. This signal strength information is then relayed to processor 207 which receives this information and undertakes one or more predetermined operations based on the signal strength information.

In some embodiments (not shown) the monitoring module 101 includes a processor. In this embodiment, the shutoff condition may be determined by the processor in the monitoring module.

The master sensor 141 contains a circuit board with transceiver and is powered continuously by a 12 volt DC regulated power supply. The slave sensor 142 is powered and operated by the master sensor 141. In embodiments where the proximity based token reader 105 is spaced apart from a pair of monitoring modules 101, the processor 207 contains a circuit board with transceiver (for example an 802.11 type transceiver) and the token reader 105 is powered continuously by a 12 volt DC regulated power supply. In other embodiments the transceiver is part of communications component 202.

The communications component 202 includes a 2.4 GHz transceiver that is in communication with a central computer system 210 (that will be described in more detail below). The preferred mode of communication is wireless communication as this, by definition, negates the need for wires that may pose a safety risk or be prone to getting in the way. However, for embodiments where the monitoring device is integrally formed with a prefabricated wall panel, the communications component can be hard-wired as these wires will be within the wall.

In other embodiments, the determining of the shutoff condition occurs at the central computer system 210.

In some embodiments, the monitoring module is configured to receive signals from the proximity reader and selectively modify its operation based on such signals. For example, the proximity reader is able to disarm the monitoring module in certain cases. This is presently implemented to disable the bed monitor when a caregiver is present, so that the caregiver can access the patient without activating an alarm.

A number of events can occur when the patient monitoring device 100 is active with the monitoring module 101 in a monitoring state. The monitoring state is defined by the monitoring device 101 being active, with no breach of the field 103, and monitoring a hospital bed occupied by a patient. Some of the more usual events are set out below.

A patient may exit from the bed 110, either intentionally or unintentionally, while a nurse is not present in the room when/where that patient is located. The patient will in doing so breach the field 103 causing the monitoring module 101 to enter an alarm state which communicates this state to the token reader 105 whereby the output 208 provides an output signal in response to the breach. This output signal is outputted to a nurse call system whereby a nurse will be alerted to the breach and be called to the location of the breach. In other embodiments, the card 106 itself receives the output signal to alert the caregiver that is in possession of that card.

In other embodiments, the output signal is outputted to an alarm unit, which is configured to raise an audible alarm (or other form of alarm). In other embodiments, the output signal is provided to a communications network which in turn arranges for a nurse or caregiver to attend to the breach.

Once a caregiver, such as a nurse, (holding their card 106) arrives to the scene of the breach, they will enter into the recognition zone 107 to attend to the patient. The reader will then read the card 106 and the processor will identify the card by the unique serial number. The processor will verify that this card is assigned to a nurse or caregiver and this will then communicate this information to the monitoring module 101 which, in response, will progress the monitoring module into a disabled state. Such a disabled state involves stopping the alarm and disarm the sensor beams 102. Once the nurse or caregiver leaves the recognition zone, the monitoring module 101 will return to the monitoring state.

In embodiments where signal strength information is received by processor 207, the monitoring module 101 will only return to the monitoring state when the card 106 leaves the recognition zone 107 and when the monitoring module 101 senses that the signal strength of card 106 decreases, indicating the caregiver is moving away from the monitoring module 101. This is advantageous if, for example, the card 106 inadvertently stops transmitting whilst in the recognition zone 107, the monitoring module 101 will not return to the monitoring state whilst the caregiver is still present.

Similar actions will occur if field 103 is breached by an outsider accessing the bed 110 of a patient.

In the case where a nurse or caregiver enters the recognition zone 107 and the mentoring module is in the monitoring state, the reader reads the card 106 and the processor identifies the card by a unique serial number. The processor then determines whether the read identifier has a predetermined authorization status. Such a status is preferably associated with cards provided to caregivers. In this manner, the patient monitor is able to recognize when a caregiver is nearby. In the case that the read identifier has the predetermined authorization status, the reader provides a signal to the monitoring module 101 which, in response, progresses into the disabled state. Once the nurse or caregiver leaves the recognition zone, the monitoring module 101 return to the monitoring state. This may be achieved by a periodic polling (for example every 10 to 30 seconds) to determine whether the relevant card remains in re recognition zone. In other embodiments, this is also achieved by the monitoring module no longer reading the card 106 within the recognition zone 107.

In some embodiments, where the token is carried by pager, and the pager is notified remotely when a breach/alarm occurs. That is, when the monitoring module 101 enters the alarm state, it provides an output signal in response to the breach, and that signal is received by a nurse's pager. Typically the pager has a receiving range of about 100 to 200 meters. In other embodiments, the receiving range will be greater than about 200 meters. In response to the output signal, the pager will maintain an audible alarm as well as a vibration alarm. As with the card 106, the monitoring module 101 returns to the monitoring state when the pager leaves the recognition zone 107.

Similar to card 106, the pager also includes a unique serial number that is identified and recorded when the pager enters the recognition zone 107.

In some embodiments, the proximity based token reader reads the token upon entry into the recognition zone. In other embodiments, the proximity based token reader will read the token only when it is wholly within the recognition zone.

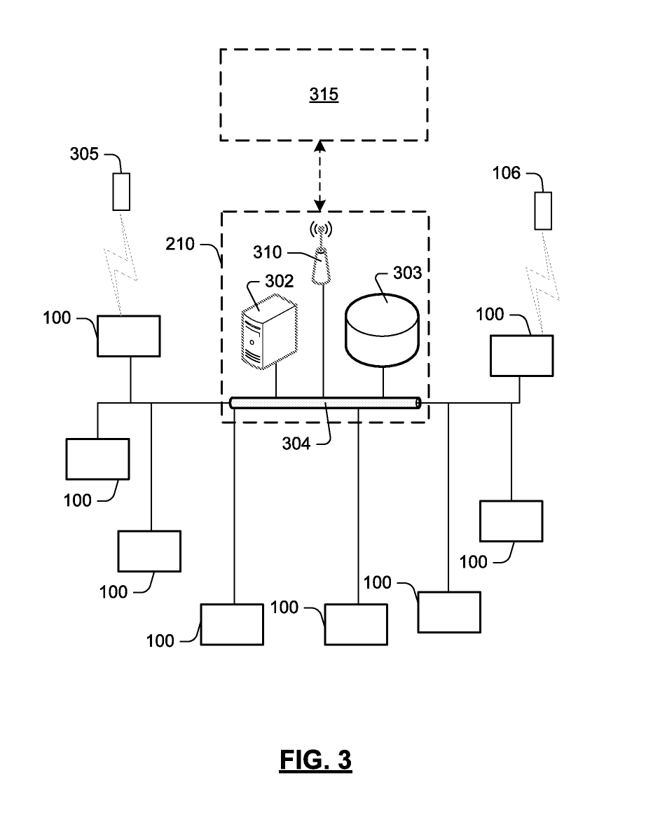

Referring now to FIG. 4, where similar reference numerals denote similar features, there is illustrated two beds (both denoted by numeral 110) and includes two types of tokens: an entry card 106 and a pager 305. The entry card 106 simply allows access to a bed without being responsive to an output signal in response to the breach of field 103. An entry card 106 will continually transmit a signal with a transmission range of about 2 to 2.5 meters. The entry card will not detect an alarm; it simply transmits a signal to allow free access to the bed. In other embodiments, card 106 will include an alert component for detecting alarms.

The pager 305 both transmits and receives information. It has all the capabilities of the entry card but can also receive an output signal (from a central computer system 210 or, in other embodiments, token reader 105) in response to the breach of field 103. The pager includes a digital readout showing the location of any breach and will vibrate and/or emit an audible alarm when a breach is first communicated to the pager.

Referring back to FIG. 3, in one embodiment a central computer system 210 receives information from the communications component 202 (shown in FIGS. 2A and 2B) of monitoring device 100. FIG. 3 illustrates several monitoring devices 100 that are linked to the central computer system 210, as would be the setup, for example, in a hospital or nursing home.

The central computer system 210 includes a main computer processor 302 and a central database 303. The central computer system 210 also includes a wireless transceiver 304 (for example an 802.11 type transceiver) for facilitating wireless communication with modules 100. However, in the preferred embodiments the central computer system 210 is hard wired to the modules 100. In embodiments, the monitoring devices are in communication with the central computer system 210 via the wireless transceiver 304. It is appreciated that the communications modules of the respective devices allow communication between the monitoring device 100 with the central computer system 210 (i.e. these may include 802.11 type network adapters).

Communications component 202 provides data indicative of the operation of the device in the form of, amongst others:
An event, for example, a breach of field 103.
An event time.

The events include, amongst others:
Operation of the device, that is, when the device is turned on or off.
Data relating to the presence of a card or pager.
A breach of the field.

The above data is then communicated to central computer system 210 where it is correlated by one or more common parameters, such as, the time of an event.

Database 303 includes information relating to the serial numbers of monitoring devices as well as the association of serial numbers of remotely readable identifiers (for example RFID tags) to a particular persons/items (e.g. nurse, visitor, patient, bed, etc). Database 303 also includes the number of the patient ward, room number and bed number.

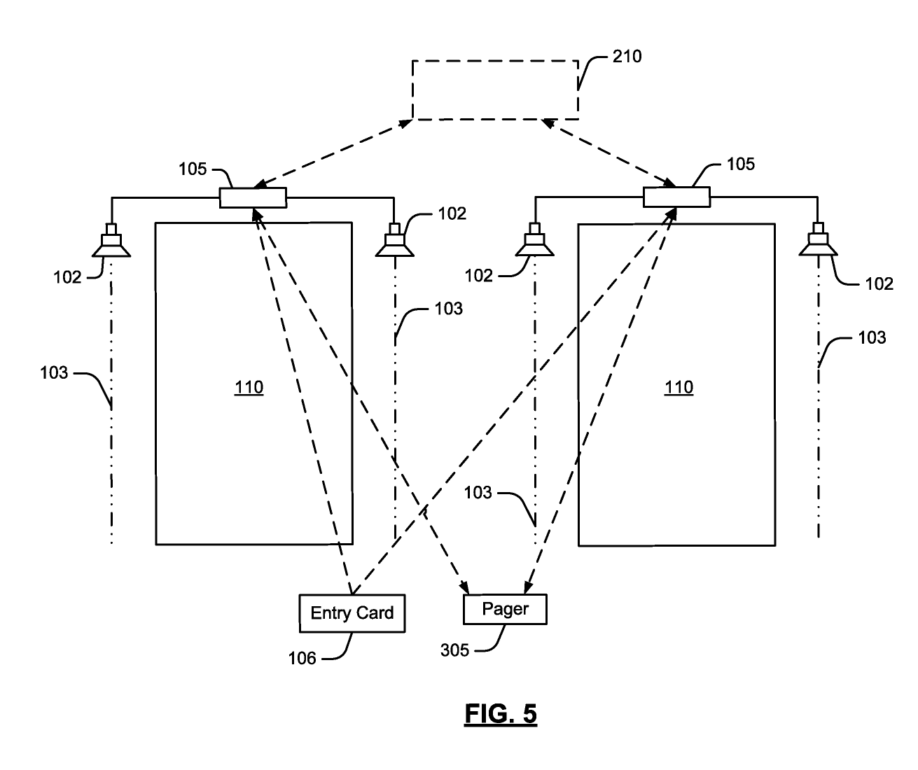

Central database, in embodiments, takes the form of an SD card 605 (as shown in the embodiments of FIG. 6).

The central computer system 210 is also in communication with a main record computer 315. In embodiments where the monitoring device 101 is used in a hospital, the main record computer 315 is the existing computer system where patient records and other hospital information are stored. Computer 315, amongst other contains, for example in a hospital, the records of the patients. This includes some or all of the following forms of information:
Patient name and/or location
Name of patient.
Patient ward.
Room number.
Bed number.
Serial number of monitoring device.
Association of serial numbers of remotely readable identifier (e.g. RFID tags) a particular persons/items (for example nurse, visitor, patient, bed, etc).

In other embodiments, the main record computer 315 is other than an existing computer system.

In other embodiments, database 303 is configured for maintaining some or all of the above information.

Central computer system 210 can run independently from main record computer 315. As such, if computer 315 fails, the patient monitoring devices 100 will continue to function properly with central computer system 210.

It is also noted that all components of the system, including the token reader 105, monitoring module 101, card 106, pager 305, and processor 302, each include a respective programmable chip. These chips are each pre-programmed such that the system operates as described above. If the system needs to be updated for any reason, the chips can be re-programmed. This is greatly advantageous as it allows the system to be updated as desired to adapt to, for example, changing systems of a hospital or nursing home.

A patient name and/or location is entered into the central computer system 210 via the main record computer 315 upon admission into the hospital, and the nurse associated with the radio-frequency identification tag is optionally entered at time of employment, when a card is issued, or beginning of the day/week. In other embodiments, the patient name and/or location is entered directly into the central computer system 210.

Whenever there is activity monitored by the monitoring device 101, this monitoring data is communicated to the central computer system 210, the computer will keep a record of the activity and stores in database 303. For example, some or all of the following information is maintained in the database based on communications form the patient monitoring devices:
Breach of field, time of day.
Time of nurse/caregiver arrival (with read identifier).
Serial number/profile of card/pager holder.
Time when system reset.
Time of nurse attending to patient (non-breach).
Time of visitor attending.

In yet further embodiments, the system of FIG. 3 can used as a tracking system so that movements of card holders can be constantly pinpointed.

The system illustrated in FIG. 3 uses the central computer system 210 as part of the nurse call system. In different embodiments, this system can be run as a stand-alone system or integrated with an existing nurse call system utilizing. FIG. 6 shows such the system integrated with a nurse call system, including a nurse-call receiver 610.

At least a subset of the data is maintained in a read-only/access protected manner, such that it is not able to be modified by staff, or alternately is only editable by staff with sufficient access rights. In other embodiments, all of the data is maintained in a read-only/access protected manner. This provides a security mechanism as the raw data records will be generally tamperproof. This is particularly advantageous as it may be required, for example, as evidence in legal proceedings for negligence. For example, if an incident occurred where a patient were to fall out of bed and an investigation took place as to why this occurred, here would be generally tamperproof records that could be relied upon. These records would show exactly what the response time (that is, for a caregiver to respond to an alarm) was for that particular incident.

In other embodiments, a similar system is either additionally or exclusively used for security purposes. In environments where patients are housed, such as hospitals and nursing homes, there is often a need to store items such as various drugs that would be used for medicinal purposes. In this case, there may be a desire to monitor who accesses such items to ensure that there is no unauthorized access. In this case, the same system would be used as for a patient, except instead of a bed, there would simply be a secure room containing the items such as various drugs.

When a nurse or caregiver enters a recognition zone around, for example, a supply room containing drugs, and the mentoring module is in the monitoring state, the reader reads the card 106 and the processor identifies the card by a unique serial number. The processor then determines whether the read identifier has a predetermined authorization status. Such a status is preferably associated with cards provided to caregivers. In the case that the read identifier has the predetermined authorization status, the reader provides a signal to the monitoring module 101 which, in response, progresses into the disabled state. Once the nurse or caregiver leaves the recognition zone, the monitoring module 101 return to the monitoring state. This may be achieved by a periodic polling (for example every 10 to 30 seconds) to determine whether the relevant card remains in re recognition zone. In other embodiments, this is also achieved by the monitoring module no longer reading the card 106 within the recognition zone 107.

All unique serial numbers and entrance and exit times from the recognition zone will be recorded similar to embodiments using a patient and a bed.

It will be appreciated that the disclosure above provides various significant systems and methods for patient monitoring. In particular, the combination of a proximity based token reader in a patient monitor provides for features and functionalities not realizable based on existing devices.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; a carrier wave bearing a propagated signal detectable by at least one processor of the one or more processors and representing the set of instructions a propagated signal and representing the set of instructions; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A patient monitoring device including:
a monitoring module including a field generator component for generating a patient monitoring field, the monitoring module being configured to generate a signal in response to a breach of that field; and
a proximity based token reader configured for remotely reading an identifier carried by a token when that token is located within a recognition zone defined relative to the proximity based token reader.

2. A patient monitoring device according to claim 1 wherein:
the proximity based token reader is configured to assess the remotely read identifier to determined whether a shutoff condition is met, and in the case that the shutoff condition is met, transmit a shutoff signal to the monitoring module; and
the monitoring module is responsive to the shutoff signal for adopting a shutoff state.

3. A patient monitoring device according to claim 2 wherein, in the case that the shutoff condition is met, the monitoring module either disables the field generator, or disables generation of the signal in response to a breach of the field.

4. A patient monitoring device according to claim 2 wherein determining whether a shutoff condition is met includes comparing the read token with a set of token assessment criteria.

5. A patient monitoring device according to claim 3 wherein the set of token assessment criteria includes one or more of:
a fully authorised read token criteria;
a partially authorised read token criteria; and
a temporary authorised read token criteria.

6. A patient monitoring device according to claim 1 wherein the module includes one or more beam sensors that project the patient monitoring field.

7. A patient monitoring device according to claim 1 wherein the device includes one or more outputs for providing an output signal externally of the device in response to a breach of the field.

8. A patient monitoring device according to claim 7 wherein the monitoring module includes a communications component for providing the output signal to any one or more of:
a nurse call system;
an alarm unit; and
a communications network.

9. A patient monitoring device according to claim 1 wherein the device includes a communications component for providing, externally of the device, data indicative of the operation of the device.

10. A patient monitoring device according to claim 9 wherein the data indicative of operation of the device includes one or more of:
an event; and
an event time.

11. A patient monitoring device according to claim 9 wherein the data includes data indicative of operation of the monitoring module.

12. A patient monitoring device according to claim 9 wherein the data includes data indicative proximity based token reader.

13. A patient monitoring device according to claim 9 wherein the data includes data indicative of the monitoring module and proximity based token reader whereby the data is correlated according to one or more common parameters.

14. A patient monitoring device according to claim 13 wherein the one or more common parameters includes a time of an event.

15. A monitoring system for storing event data including:
a patient monitoring device according to any one of the preceding claims; and
central database for receiving and storing, from the device, event data indicative of the operation of the device.

16. A monitoring system for storing event data including:
a patient monitoring device according to any one of the preceding claims; and
one or more computers having a database for receiving and storing, from the device, event data indicative of the operation of the device.

17. A patient monitoring device according to claim 1 wherein the device is mounted to a bed.

18. A patient monitoring device according to claim 1 wherein the device is mounted to a wall.

19. A patient monitoring device according to claim 1 wherein the device is mounted to a stand that can be set at a predetermined height above the floor.

20. A patient monitoring device according to claim 1 wherein the device is integrally formed into a wall panel.

21. A recognition token for use with the patient monitoring device of any of the preceding claims wherein the card includes a unique identifier.

22. A method for operating a patient monitoring device including:
using a monitoring module including a field generator component to generate a patient monitoring field, the monitoring module being configured to generate a signal in response to a breach of that field; and
providing a proximity based token reader configured for remotely reading an identifier carried by a token when that token is located within a recognition zone defined relative to the proximity based token reader.

23. A method for operating a patient monitoring device according to claim 22, the method including:
remotely reading an identifier carried by a token when that token is located within the recognition zone defined relative to the proximity based token reader; and
selectively providing a signal in response to reading the token.

24. A method according to claim 23 wherein the signal includes a signal for either disabling the field generator, or disabling generation of the signal in response to a breach of the field.

25. A computer readable medium carrying a set of instructions that when executed by one or more processors cause the one or more processors to perform a method according to any one of claims 22 to 24.

26. A method substantially as herein described with reference to any one of the embodiments of the invention illustrated in the accompanying drawings and/or examples.

27. A patient monitor substantially as herein described with reference to any one of the embodiments of the invention illustrated in the accompanying drawings and/or examples.
